(19) United States
(12) Patent Application Publication
(10) Pub. No.: US 2024/0069475 A1
(43) Pub. Date: Feb. 29, 2024

(54) HEATING BELT SUPPORTED BY MEMBER HAVING PROTRUDING REGION

(71) Applicant: HEWLETT-PACKARD DEVELOPMENT COMPANY, L.P., Spring, TX (US)

(72) Inventors: Sun Hyung LEE, Seongnam-si (KR); Sea Chul BAE, Seongnam-si (KR); Sung Woo KANG, Seongnam-si (KR)

(21) Appl. No.: 17/909,802

(22) PCT Filed: Mar. 9, 2021
(86) PCT No.: PCT/US2021/021457

§ 371 Date: Sep. 7, 2022

(30) Foreign Application Priority Data
Mar. 13, 2020 (KR) 10-2020-0031149

(51) Int. Cl. G03G 15/20

(52) U.S. Cl. CPC G03G 15/2053

(57) ABSTRACT

A fuser includes a pressure roller to rotate, a heating belt to form a fixing nip with the pressure roller; and bushings at each end of the heating belt, respectively, to support the heating belt. Each of the bushings includes a side wall outside the each end of the heating belt, and a support member in a direction toward the heating belt with respect to the side wall to support an inner surface of the heating belt, where the support member includes a protruding region downwardly inclined in a direction toward the side wall.

### BACKGROUND

An image forming apparatus prints an image on a print medium. An image forming apparatus includes a printer, a copier, a fax machine, and a multifunction machine that incorporates functions of those devices. An electrophotographic image forming apparatus uses a fuser that forms a developer image corresponding to print data on a print medium and permanently fixes the developer image on the print medium by applying a predetermined heat and pressure to the developer image.

The fuser may include a pressure roller applying a predetermined pressure to the print medium, a heating belt applying a predetermined heat to the print medium, and bushes (also referred to as bushings) installed on each end of the heating belt to support the heating belt.

### BRIEF DESCRIPTION OF THE DRAWINGS

FIG. 1 is a cross-sectional view schematically showing an image forming apparatus having a fuser according to an example.

FIG. 2 is a perspective view showing a fuser according to an example.

FIG. 3 is an exploded perspective view of the example of the fuser shown in FIG. 2.

FIG. 4 is a cross-sectional view taken along line 1-1 of the example shown in FIG. 2.

FIG. 5 is a partial perspective view showing a state in which bushes (bushings) support a heating belt according to an example.

FIG. 6 is a front view of a protruding region provided on a support member as viewed from an upstream side according to an example.

FIG. 7 is a view showing another example of a protruding region.

### DETAILED DESCRIPTION

Hereinafter, various examples will be described with reference to the drawings. The examples described hereinafter may, however, be embodied in many different forms. In the following description, well-known functions or constructions are not described in detail for clarity of description when it is determined that they are well known to those of ordinary skilled in the art.

It will be understood that when an element is referred to as being “connected to” or “coupled to” another element, it may be “directly connected or coupled” to the other element, or “indirectly connected or coupled” to the other element, with intervening elements therebetween. It will be further understood that the terms “comprises,” “comprising,” “includes,” and/or “including” when used herein, specify the presence of components, but do not preclude the presence or addition of one or more other components, unless otherwise specified.

In addition, an “image forming apparatus” may refer to an apparatus operable to print data generated by a terminal device such as a computer on a print medium. Examples of such an image forming apparatus include a copier, a printer, a facsimile, or a multi-function printer (MFP) that implements functions of aforementioned devices in a single device.

It should be understood that the examples disclosed herein are illustrative for better understanding of the disclosure, and that the disclosure may be modified in various ways.

In the following description, when a detailed description of a relevant known function or configuration is determined to unnecessarily obscure the gist of the disclosure, the detailed description and specific illustration will be omitted. In addition, for ease understanding of the disclosure, the accompanying drawings are not drawn to real scale, but the dimensions of some components may be exaggerated.

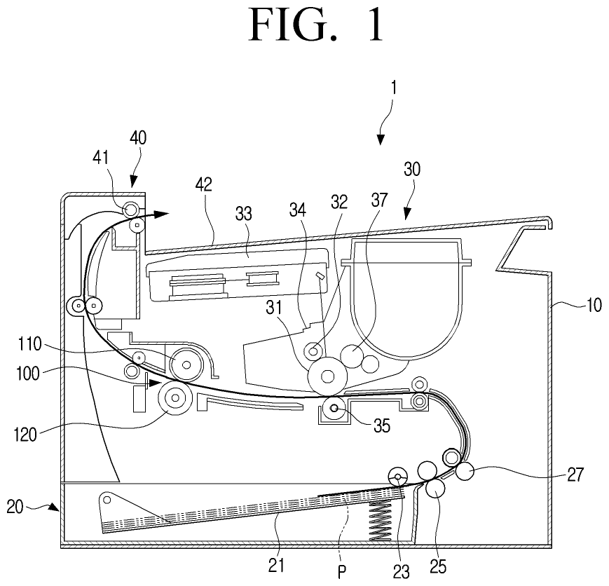

FIG. 1 is a cross-sectional view schematically showing an image forming apparatus 1 having a fuser 100 according to an example.

The image forming apparatus 1 may include a main body 10, a paper feeder 20, a print engine 30, the fuser 100, and a discharge device 40.

The main body 10 forms an appearance of the image forming apparatus 1 and may support various parts installed therein.

The paper feeder 20 may include a paper feed tray 21 at a lower portion of the main body 10, a pick-up roller 23 that picks up print mediums P (for example, paper) loaded in the paper feed tray 21 one by one, a registration roller (or regi roller) 25 that provides a transfer force to the picked-up print medium P and evenly aligns the print medium P to allow an image to be transferred to a desired portion of the print medium P, and a paper feed roller 27 that feeds the print medium P between a photosensitive drum 31 and a transfer roller 35.

The print engine 30 may form a predetermined image on the print medium P supplied from the paper feeder 20. The print engine 30 may include the photosensitive drum 31, a charger 32, an exposure device 33, a developing device 34, and the transfer roller 35.

An electrostatic latent image may be formed on the photosensitive drum 31. For example, an image may be formed on the photosensitive drum 31 by an operation of the charger 32 and the exposure device 33, which will be described later.

Hereinafter, for the purposes of description, a configuration of the print engine 30 corresponding to one color will be described as an example, but when implemented, the print engine may include a plurality of photosensitive drums 31 corresponding to a plurality of colors, a plurality of chargers 32, a plurality of exposure devices 33 and a plurality of developing devices 34, an intermediate transfer belt, and the like.

The charger 32 may charge a surface of the photosensitive drum 31 with a uniform potential.

The exposure device 33 may form an electrostatic latent image on the surface of the photosensitive drum 31 by changing the surface potential of the photosensitive drum 31 according to image information to be printed.

The developing device 34 may accommodate a developer therein and supply the developer (e.g., toner) to the electrostatic latent image to develop the electrostatic latent image into a visible image. The developing device 34 may include a developing roller 37 supplying the developer to the electrostatic latent image.

The transfer roller 35 may be installed to face an outer circumferential surface of the photosensitive drum 31.

The fuser 100 may apply heat and pressure, while the print medium P to which the developer image has been transferred at the print engine 30 to fix the developer image on the print medium P, which will be described below.

In addition, the discharge device 40 may include an exit roller 41 that discharges the print medium P on which a predetermined image has been printed through the fuser 100 to an exit tray 42 outside the main body 10.

The configuration of the image forming apparatus 1 according to an example has been described in detail above, but the development method is not limited thereto and the configuration of the image forming apparatus 1 according to the development method may be variously modified and changed.

Hereinafter, the fuser 100 according to an example will be described in detail with reference to the drawings.

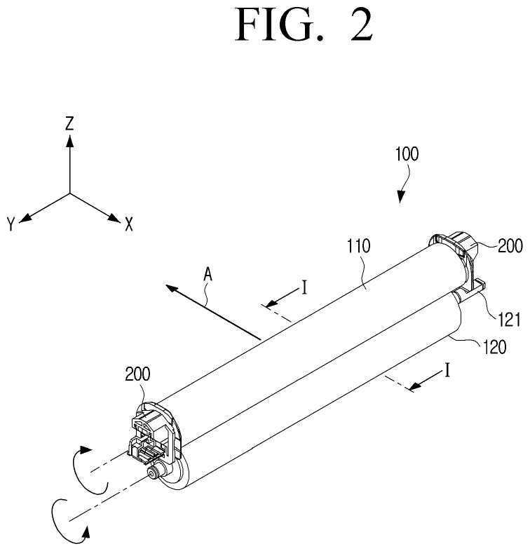

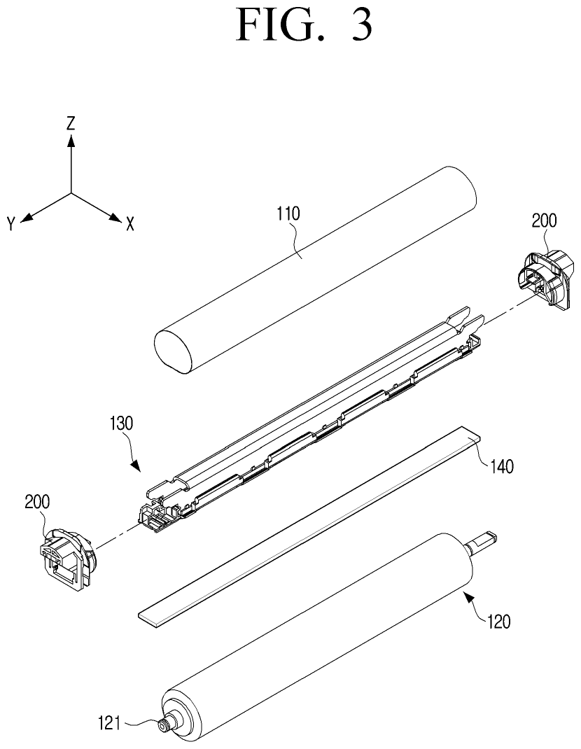

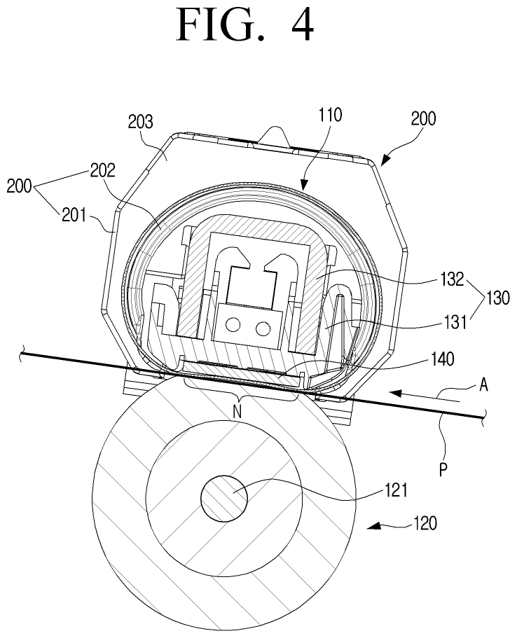

FIG. 2 is a perspective view showing the fuser 100 according to an example, FIG. 3 is an exploded perspective view of the fuser 100 shown in the example of FIG. 2, and FIG. 4 is a cross-sectional view taken along line 1-1 of the example shown in FIG. 2.

Referring to FIGS. 2 to 4, the fuser 100, which applies heat and pressure to the print medium P to fix the transferred developer image on the print medium, may include a heating belt 110, a pressure roller 120, a nip forming member 130, a heat source 140, and a bush (also referred to as bushing) 200.

The heating belt 110 may have the heat source 140 providing heat to the print medium on which an image has been transferred at the developing device. For example, the heating belt 110, which applies a predetermined heat to the print medium (P), is illustrated as a belt type heating belt but the heating belt 110 is not limited thereto and may be configured as a roller type heating belt.

The heating belt 110 may be heated by the heat source 140, which will be described later, and transfer heat to the print medium P passing between the heating belt 110 and the pressure roller 120.

The heating belt 110 may be installed to face the pressure roller 120 and may form a fixing nip N through which the print medium P passes along with the pressure roller 120.

The pressure roller 120 may rotate around a rotary shaft 121. When the pressure roller 120 rotates, the heating belt 110 may rotate passively by a frictional force between the heating belt 110 and the pressure roller 120.

An axial length of the heating belt 110 may be formed longer than an axial length of the pressure roller 120. The heating belt 110 may include a single layer of a metal, a heat-resistant polymer, or the like or may include an elastic layer and a protective layer in addition to a base layer formed of a metal or heat-resistant polymer.

For example, the heating belt 110 may include at least one material of a polyimide resin or stainless steel (steel use stainless (SUS)).

The pressure roller 120 may be installed to face the heating belt 110 to maintain a constant fixing pressure between the pressure roller 120 and the heating belt 110. For example, the pressure roller 120, which applies a predetermined pressure to the print medium P, may be formed in a roller shape. The pressure roller 120 may be configured to rotate by power transferred from a driving source such as a motor.

The nip forming member 130 may be installed inside the heating belt 110 and may support an inner surface of the heating belt 110 so that the heating belt 110 may be in contact with the pressure roller 120 to form the fixing nip N.

In addition, the nip forming member 130 may be formed longer than the pressure roller 120. Therefore, when the pressure roller 120 is in contact with the heating belt 110 to form the fixing nip N, bending of each end of the heating belt 110 by the pressure roller 120 may be prevented.

The nip forming member 130 may include a guide member 131 in contact with the inner surface of the heating belt 110 to guide and press the heating belt 110 and a stay 132 disposed above the guide member 131 to support the guide member 131.

The guide member 131 may be in contact with the inner surface of the heating belt 110 to form the fixing nip N and guide the heating belt 110 so that the heating belt 110 may run smoothly near the fixing nip N. The guide member 131 has a channel-shaped (U-shaped) cross-section in which a bottom thereof is substantially flat, and the stay 132 is installed inside thereof. A plurality of guide ribs may be provided on opposing side surfaces of the guide member 131 in a longitudinal direction.

The stay 132 may reinforce the guide member 131 to minimize bending deformation of the guide member 131. The stay 132 may be formed in a channel shape having a U-shaped cross section with a substantially flat bottom, and is installed inside the guide member 131. The stay 132 may be formed in a structure having a large geometrical moment of inertia such as an I-beam or an H-beam, in addition to the U-shape with a flat bottom.

As shown in FIG. 4, a lower surface of the nip forming member 130, i.e., a lower surface of the guide member 131, is in contact with the inner surface of the heating belt 110, and an upper portion of the pressure roller 120 in contact with a portion of the heating belt 110 supported by the lower surface of the guide member 131 may form the fixing nip N.

The heat source 140, which is configured to generate heat applied to image fixing, may be provided as a heat lamp (e.g., a halogen lamp) or a heating resistor. The heat source 140 may be disposed in the heating belt 110 along a rotary shaft of the heating belt 110.

For example, the heat source 140 may be disposed on a bottom surface of the nip forming member 130. In this case, a heat blocking member may be disposed between the nip forming member 130 and the heat source 140 to prevent heat generated by the heat source 140 from being directly radiated to the nip forming member 130. The heat source 140 may be configured as various heat sources such as a halogen lamp, a heating wire, or an induction heater.

A pair of bushes (bushings) 200, which may be disposed at each end of the heating belt 110, supports the inner surfaces of each end of the heating belt 110, and limits movement of the heating belt 110 in a direction of a central axis, which will be described in detail below.

Although not shown, a pair of sliding members may be provided between the heating belt 110 and the pair of bushes (bushings) 200 to minimize an occurrence of fatigue cracks at the each end of the heating belt 110 when the heating belt 110 is rotated by the pressure roller 120.

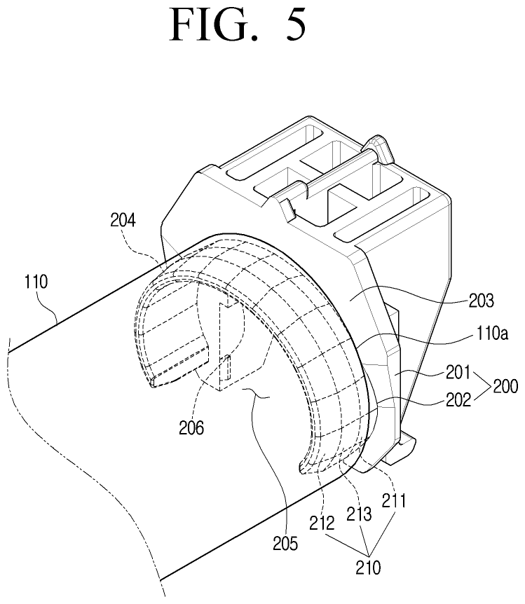

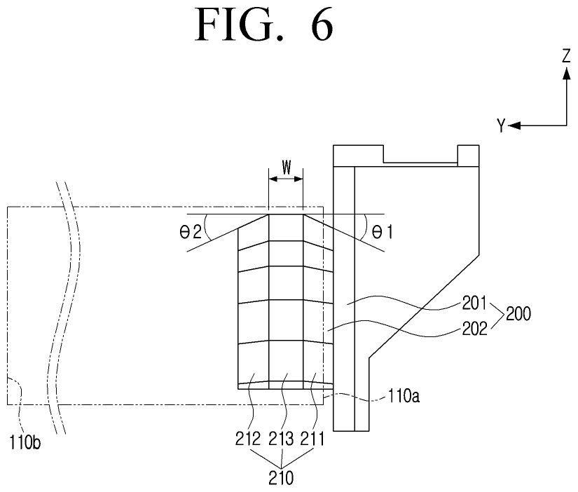

FIG. 5 is a partial perspective view showing a state in which the bushes (bushings) 200 support one end 110a of the heating belt 110. FIG. 6 is a front view of a protruding region 210 provided on a support member 202 as viewed from an upstream side.

Referring to FIGS. 5 and 6, the bushes (bushings) 200, which support the each end of the heating belt 110, may include a side wall 201 and the support member 202.

The side wall 201 may be disposed outside the each end of the heating belt 110 and supported to be slidable up and down on a support bracket (not shown) of the fuser. The side wall 201 may be formed in an approximately octagonal shape but is not limited thereto.

A front surface of the side wall 201 may have a regulating surface 203 regulating an axial movement of the heating belt 110. Accordingly, the heating belt 110 may move in an axial direction until one end 110a contacts the regulating surface 203.

The regulating surface 203 may have a partially cut shape to avoid interference between the side wall 201 and a counterpart component. That is, the side wall 201 may form an internal space 205 including a recess formed by a predetermined depth on the regulating surface 203.

Accordingly, because the nip forming member 130 is accommodated in the internal space 205 of the side wall 201, the nip forming member 130 may avoid interference with the side wall 201.

The support member 202 may protrude in a direction toward the heating belt 110 with respect to the side wall 201 and support the inner surface of the heating belt 110 so that the heating belt 110 may rotate.

The support member 202 may have an arch shape but is not limited thereto and may be formed in various shapes as long as the support member 202 provides a path along which the heating belt 110 may rotate naturally.

An upper portion of the support member 202 may have a guide surface 204 facing the inner surface of the heating belt 110. That is, the inner surface of the heating belt 110 may rotate in contact with the entirety or part of the guide surface 204.

Because the support member 202 supports the inner surface of the heating belt 110 that rotates at a fixed position, friction may occur in a region in which the guide surface 204 of the support member 202 is in contact with the heating surface 110.

The friction that occurs between the inner surface of the heating belt 110 and the guide surface 204 of the support member 202 may cause the heating belt 110 and the support member 202 to wear to result in a reduction of life.

In the bush (bushing) 200 according to the related art, the support member 202 in contact with the inner surface of the heating belt 110 is inclined in one direction toward the heating belt 110 to reduce an area in which the heating belt 110 and the support member 202 are in contact with each other to thereby reduce wear that occurs on the inner surface of the heating belt 110.

However, the each end 110a and 110b of the heating belt 110 are in contact with the support member 202 inclined in one direction and stress concentrates thereon, wear is aggravated. Therefore, there is a need to develop the fuser100 capable of reducing wear occurring at the each end 110a and 110b as well as the inner surface of the heating belt 110.

Thus, the support member 202 according to an example may form the protruding region 210 on the guide surface 204 to reduce the amount of wear between both components.

The protruding region 210 may have a shape inclined downward in the direction toward the side wall 201 on the guide surface 204 of the support member 202. In addition, the protruding region may be inclined downward toward the side wall 201 and also toward the other end 110b of the heating belt 110.

For example, the protruding region 210 may include a first inclined region 211, a second inclined region 212, and a contact region 213.

The first inclined region 211 is inclined downward in the direction toward the side wall 201, the second inclined region 212 is inclined downward in the direction toward the heating belt 110, and the contact region 213 may be disposed between the first and second inclined regions 211 and 212 and may be in contact with the inner surface of the heating belt 110.

The contact region 213 is shown flat in FIG. 6 but the shape is not limited thereto. That is, the contact region 213 may have a convex shape toward the inner surface of the heating belt 110.

The protruding region 210 may be formed along an outer circumferential surface of the support member 202 having an arch shape. That is, the protruding region 210 may be formed on the guide surface 204 of the support member 202 in a rotation direction of the heating belt 110.

As the protruding region 210 has the above-described shape and is formed on the guide surface 204 of the support member 202, the area in which the inner surface of the heating belt 110 and the guide surface 204 of the support member 202 are in contact with each other may be reduced.

For example, the heating belt 110 is not entirely in contact with the guide surface 204 but rather mainly in contact with the contact region 213 of the protruding region 210, and thus wear due to contact with the support member 202 may be reduced.

In addition, because the protruding region 210 is inclined downward in the direction toward the side wall 201 or includes the first and second inclined regions 211 and 212 which are inclined downward in mutually opposite directions, one end 110a of the heating belt 110 may rotate without contacting the guide surface 204 of the support member 202.

Accordingly, one end 110a and the other end 110b, as well as the inner surface, of the heating belt 110, are reduced in wear, a user may use the heating belt 110 for a long period of time.

In addition, even if meandering in which the heating belt 110 moves in the axial direction occurs, a height difference between the each end 110a and 110b of the heating belt 110 does not occur, and thus the heating belt 110 may stably rotate while a rotary shaft thereof is kept parallel to the rotary shaft 121 of the pressure roller 120.

Angles Θ₁ and Θ₂ at which the protruding region 210 is downwardly inclined toward one end 110a and the other end 110b of the heating belt 110 may be 1 to 4 degrees, respectively. For example, the first angle θ₁ between the first inclined region 211 and the contact region 213 and the second angle Θ₂ between the second inclined region 212 and the contact region 213 may be 1 to 4 degrees.

The first angle θ₁ and the second angle θ₂ may have different values, but are not limited thereto. That is, the first angle θ₁ and the second angle θ₂ may be the same or may have an optimal value at which the amount of wear of the inner surface of the heating belt 110 and the guide surface 204 of the support member 202 is the smallest, while the amount of wear thereof is measured.

In addition, the protruding region 210 may include the second inclined region 212 inclined downward in the direction toward the side wall 201. That is, the first angle θ₁ may be G degrees. Accordingly, the one end 110a of the heating belt 110 rotates without contacting the guide surface 204 of the support member 202 even due to the protruding region 210 having the above-described shape, reducing wear of one end 110 and the other end 110b, as well as the inner surface, of the heating belt 110, and thus the user may use the heating belt 110 for a long period of time.

The protruding region 210 may be bilaterally symmetrical with respect to a vertical direction (Z-axis direction). That is, the protruding region 210 may have the contact region 213 at the center and the first and second angles Θ₁ and Θ₂ have the same value to have a symmetrical shape based on the vertical direction.

The protruding region 210 may have continuous slopes. For example, the protruding region 210 may have continuous slopes at the boundaries between the contact region 213 and the first and second inclined regions 211 and 212, respectively. Although shown as having an angular shape, the protruding region 210 may be in a gently curved shape on both sides with respect to the contact region 213.

Accordingly, even if meandering in which the heating belt 110 moves in the axial direction occurs, the inner surface of the heating belt 110 moves smoothly and naturally on the protruding region 210, thus preventing the inner surface of the heating belt 110 from being scratched by the protruding region 210 or one end 110a from being moved and folded at the boundary between the regions of the protruding region 210.

In addition, a width W of the contact region 213 of the protruding region 210 may be 0.1 mm to 1 mm, but is not limited thereto. If the width W of the contact region 213 is narrow, the protruding region 210 may have a pointed shape to cause stress to concentrate on the inner surface of the heating belt 110 in contact with the protruding region 210 to scratch or tear the heating belt 110.

Conversely, if the width W of the contact region 213 is wide, the protruding region 210 has a flat shape, and thus an effect according to the inclined shape of the protruding region 210 described above cannot be expected. Therefore, because the contact region 213 having the width of 0.1 mm to 1 mm is in contact with the heating belt 110, the amount of wear of the heating belt 110 may be reduced and damage to the heating belt 110 due to the protruding region 210 may be prevented.

The bushes (bushings) 200 may include the side wall 201 formed of a resin containing glass fiber (GF) and the support member 202 formed of a resin not containing glass fiber.

If the support member 202 is formed of a resin containing glass fiber, the inner surface of the heating belt 110 in contact with the support member 202 may be rapidly worn by the glass fiber component having high rigidity.

Accordingly, because the support member 202 in direct contact with the heating belt 110 is formed of a resin not containing glass fiber, wear that occurs on the inner surface of the heating belt 110 may be reduced.

Meanwhile, the side wall 201, which is not in direct contact with the heating belt 110, is formed of a resin containing a glass fiber component having excellent heat resistance, thereby maintaining a shape and rigidity thereof even at a high temperature of the heating belt 110.

In addition, the entirety of the support member 202 may not be formed of the same material but the protruding region 210 or the contact region 213 may be formed of a resin that does not contain glass fiber. That is, the region of the support member 202 facing or directly contacting the inner surface of the heating belt 110 may be formed of a resin that does not contain glass fiber.

The support member 202 may not be integrally formed with the sidewall 201 but may be formed separately and detachably coupled to the sidewall 201. Accordingly, because the support member 202 is manufactured in a separate process from the side wall 201, the support member 202 may be easily formed of a material different from the side wall 201.

In addition, when the support member 202 of the bush (bushing) 200 needs to be replaced, the user may separately replace the support member 202 from the side wall 201 without having to replace the entirety of the bushes (bushings) 200, thereby preventing inefficiency that the entirety of the bushes (bushings) 200 needs to be replaced unnecessarily.

A spring (not shown) may be connected to a lower surface 206 of the support member 202. Because the spring elastically supports the support member 202, the support member 202 may have a certain level of fluidity. For example, when the inner surface of the heating belt 110 presses the guide surface 204 of the support member 202, the spring may be compressed and the support member 202 may move in the pressing direction.

The spring may be provided between the support member 202 and the nip forming member 130, but is not limited thereto. In addition, a fluid or other elastic body, as well as the spring, may also be used to elastically support the support member 202.

Accordingly, because a normal force of the support member 202 acting on the heating belt 110 is reduced, a magnitude of a frictional force acting on the inner surface of the heating belt 110 may be reduced, thus reducing wear that occurs on the inner surface of the heating belt 110.

In addition, if the support member 202 is detachably coupled to the side wall 201 as described above, the support member 202 may not flow integrally with the side wall 201, and thus fluidity of the support member 202 may increase the effect described above.

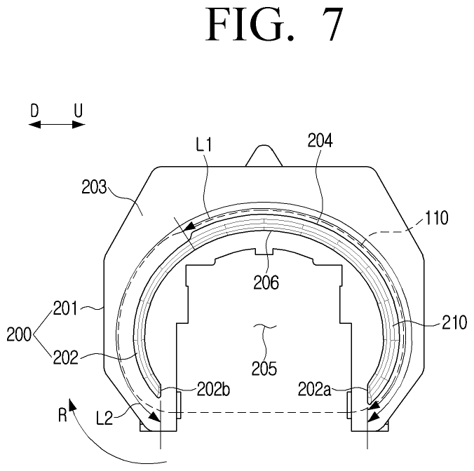

FIG. 7 is a diagram illustrating another example of the protruding region 210 according to an example. Referring to FIG. 7, the protruding region 210 may be formed on a part of the support member 202.

The heating belt 110 may be subjected to a frictional force to a downstream side D by the pressure roller 120 at the fixing nip N, and thus the heating belt 110 may rotate in a clockwise direction R, in a state of being leaned toward the downstream side D. The dotted line in FIG. 7 may indicate a rotation trace of the heating belt 110.

That is, the heating belt 110 is in strong contact with an upstream side U of the support member 202, but rotates in a state leaned toward the downstream side D, the heating belt 110 may not substantially in contact with the downstream side D of the support member 202.

Accordingly, even though the protruding region 210 is provided at a part of the support member 202, rather than the entirety thereof, the same effect of reducing wear of the heating belt 110 may be obtained because the protruding region 210 is provided at a portion where the heating belt 110 and the guide surface 204 are in contact with each other.

For example, the protruding region 210 is provided on the outer circumferential surface of the support member 202 from the upstream U end 202a to which the print medium is supplied among the each end 202a and 202b of the support member 202, and the region where the protruding region 210 is provided among the entirety of the support member 202 may correspond to a partial region of ½ to ⅘ of the entirety of the support member 202. That is, a length L1 of the protruding region 210 may be ½ to ⅘ of a length L2 of the support member 202.

Thus, even if the protruding region 210 is provided at the part of the upstream side U and downstream side D of the support member 202, without having to be provided in the entirety of the support member 202, wear that occurs on the inner surface of the heating belt 110 may be effectively reduced.

While the disclosure has been described with reference to the accompanying drawings, it is to be understood that the scope of the disclosure is defined by the claims described hereinafter and should not be construed as being limited to the above-described examples and/or drawings. It is to be clearly understood that improvements, changes, and modifications that are obvious to those skilled in the art are also within the scope of the disclosure as defined in the claims.

1. A fuser comprising:
a pressure roller to rotate;
a heating belt to form a fixing nip with the pressure roller; and
bushings at each end of the heating belt, respectively, to support the heating belt, each of the bushings including:
a side wall outside of the each end of the heating belt; and
a support member in a direction toward the heating belt with respect to the side wall to support an inner surface of the heating belt and the support member including a protruding region downwardly inclined in a direction toward the side wall, wherein the support member is detachably coupled to the side wall.

2. The fuser as claimed in claim 1, wherein
the protruding region includes a first inclined region downwardly inclined in the direction toward the side wall, a second inclined region downwardly inclined in the direction toward the heating belt, and a contact region disposed between the first and second inclined regions.

3. The fuser as claimed in claim 2, wherein
the protruding region including a shape gently bent to each side with respect to the contact region.

4. The fuser as claimed in claim 2, wherein a width of the contact region is 0.1 mm to 1 mm.

5. The fuser as claimed in claim 2, wherein
a tilt angle of the first inclined region and a tilt angle of the second inclined region are different.

6. The fuser as claimed in claim 1, wherein a tilt angle of the protruding region is 1 to 4 degrees.

7. The fuser as claimed in claim 1, wherein
the support member including an arch shape, and the protruding region is along an outer circumferential surface of the support member.

8. The fuser as claimed in claim 1, wherein
the protruding region is bilaterally symmetrical with respect to a vertical direction.

9. The fuser as claimed in claim 1, wherein
the protruding region is at a part of the support member.

10. The fuser as claimed in claim 9, wherein
the protruding region is along an outer circumferential surface of the support member from an upstream side end to which a print medium is supplied, among each end of the support member, and a region of the entirety of the support member including the protruding region corresponds to a partial region of ½ to ⅘ of the entirety of the support member.

11. The fuser as claimed in claim 1, wherein
the support member including a resin not containing glass fiber.

12. The fuser as claimed in claim 1, further comprising:
a spring to elastically support the support member.

13. An image forming apparatus comprising:
a photosensitive drum to include a latent image;
a developing device to supply a toner to the photosensitive drum to form a toner image corresponding to the latent image; and
a fuser to pressure a print medium to which the toner image is transferred and including:
a pressure roller to rotate;
a heating belt to form a fixing nip with the pressure roller; and
bushings at each end of the heating belt to support the heating belt and including:
a side wall outside of the each end of the heating belt; and
a support member in a direction toward the heating belt with respect to the side wall to support an inner surface of the heating belt and the support member including a protruding region downwardly inclined in a direction toward the side wall, wherein the support member is detachably coupled to the side wall.

14. The image forming apparatus as claimed in claim 13, wherein
the protruding region includes a first inclined region downwardly inclined in the direction toward the heating belt, a second inclined region downwardly inclined in the direction toward the side wall, and a contact region disposed between the first and second inclined regions.

15. The image forming apparatus as claimed in claim 13, wherein
the protruding region is along an outer circumferential surface of the support member from an upstream side end to which the print medium is supplied, among each end of the support member, and a region of the entirety of the support member including the protruding region corresponds to a partial region of ½ to ⅘ of the entirety of the support member.
